(19) United States
(12) Patent Application Publication
(10) Pub. No.: US 2024/0183702 A1
(43) Pub. Date: Jun. 6, 2024

(54) MASS FLOW CONTROL DEVICE AND ZERO POINT CALIBRATION METHOD FOR THE SAME

(71) Applicant: Samsung Electronics Co., Ltd., Suwon-si (KR)

(72) Inventors: Seunghun Kim, Suwon-si (KR); Kyungho Kang, Suwon-si (KR); Seungmin Ryu, Suwon-si (KR); Donghoon Park, Suwon-si (KR); Minseok Seo, Suwon-si (KR); Jiho Uh, Suwon-si (KR); Seunglae Cho, Suwon-si (KR)

(21) Appl. No.: 18/519,696

(22) Filed: Nov. 27, 2023

(30) Foreign Application Priority Data
Dec. 5, 2022 (KR) 10-2022-0168130

(51) Int. Cl. G01F 25/00; G01F 25/10

(52) U.S. Cl. CPC G01F 25/0084; G01F 25/10

(57) ABSTRACT

A method of calibrating a zero point of a mass flow control device includes closing a valve installed in a main flow path of the mass flow control device to block the main flow path and prevent a fluid from flowing in the main flow path, determining, based on a pressure value measured using a pressure meter installed in the main flow path, whether the fluid has stopped flowing, determining, based on a flowrate value measured by a flowrate sensor provided on a sensor flow path connected to the main flow path, whether the fluid is stable, calculating a zero point calibration value based on a temperature value of the fluid measured by a thermometer installed in the main flow path and the flowrate value measured by the flowrate sensor, and applying the zero point calibration value to a zero point of the flowrate sensor.

### CROSS-REFERENCE TO RELATED APPLICATION

This application is based on and claims priority under 35 U.S.C. § 119 to Korean Patent Application No. 10-2022-0168130, filed on Dec. 5, 2022, in the Korean Intellectual Property Office, the disclosure of which is incorporated by reference herein in its entirety.

### BACKGROUND

The present disclosure relates to a mass flow control device and a method for calibrating a zero point for the mass flow control device.

Mass flow control devices (or mass flow controllers (MFCs)) are used to measure and control the flowrate of gas supplied to a process chamber in semiconductor manufacturing processes. Mass flow control devices control the flowrate of gas to accurately supply a controlled amount of gas to the semiconductor manufacturing process to enhance the quality of the process.

### SUMMARY

Embodiments of the inventive concepts disclosed herein provides a mass flow control device configured to accurately measure the flowrate of a fluid, such as a gas, and thereby improve the quality of processing using the fluid, and a zero point calibration method for the mass flow control device to maintain the accuracy of the measurement of the flowrate of the fluid.

Embodiments of the inventive concepts disclosed herein are not limited to those mentioned above, and the inventive concept will be apparent to those skilled in the art through the following description.

According to an aspect of the present disclosure, there is provided a method of calibrating a zero point of a mass flow control device. The method includes closing a valve installed in a main flow path of the mass flow control device to block the main flow path and prevent a fluid from flowing along the main flow path, determining, based on a pressure value measured using a pressure meter installed in the main flow path, that the fluid does not leak from the main flow path, determining, based on a flowrate value measured by a flowrate sensor provided on a sensor flow path connected to the main flow path, that the fluid is stable in the main flow path, calculating a zero point calibration value based on a temperature value of the fluid measured by a thermometer installed in the main flow path and the flowrate value measured by the flowrate sensor, and applying the calculated zero point calibration value to a zero point of the flowrate sensor.

According to another aspect of the inventive concept, there is provided a mass flow control device. The mass flow control device includes a main flow path, a sensor flow path, a first valve, a second valve, a pressure meter, a thermometer, a flowrate sensor, and a controller. The main flow path includes an inflow path through which a fluid is introduced, an outflow path through which the fluid is discharged, and a bypass flow path extending between the inflow path and the outflow path. The sensor flow path extends between the inflow path and the outflow path. The first valve is provided in the inflow path, and the second valve is provided in the outflow path. The pressure meter and the thermometer are provided in the main flow path between the first valve and the second valve. The flowrate sensor is provided on the sensor flow path. The controller is configured to receive measured values from the flowrate sensor, the pressure meter, and the thermometer, and calibrate a zero point of the flowrate sensor. The controller is further configured to determine, based on a pressure value measured by the pressure meter, whether the fluid has stopped flowing when the main flow path is closed by the first valve and the second valve, determine, based on a flowrate value measured by the flowrate sensor, whether the fluid is stable, calculate a zero point calibration value based on a temperature value of the fluid measured by the thermometer provided in the main flow path and the flowrate value measured by the flowrate sensor, and apply the zero point calibration value to the zero point of the flowrate sensor.

According to another aspect of the inventive concept, there is provided a method of calibrating a zero point of a mass flow control device. The method includes closing a valve installed in a main flow path of the mass flow control device to block the main flow path and prevent a fluid from flowing along the main flow path, determining that the fluid does not leak, based on a pressure value measured by a pressure meter installed in the main flow path by determining that a rate of change of the pressure value with respect to time is less than or equal to a reference value, determining that the fluid is stable, wherein the fluid is determined to be stable when a standard deviation of flowrate values measured during a reference time period by a flowrate sensor provided on a sensor flow path connected to the main flow path is less than or equal to a reference value, and a difference between a maximum value and a minimum value of the flowrate values measured by the flowrate sensor during the reference time period is less than or equal to a reference value, determining that the reference time period for measurement by the pressure meter, the flowrate sensor, and a thermometer provided in the main flow path has elapsed, calculating a zero point calibration value based on a temperature value of the fluid measured by the thermometer and the flowrate values measured by the flowrate sensor, and applying the zero point calibration value to a zero point of the flowrate sensor. The zero point calibration value is proportional to an average flowrate calculated from flowrate values measured by the flowrate sensor over time and is proportional to a calibration weight value. The calibration weight value is inversely proportional to the temperature value measured by the thermometer, and is inversely proportional to a greater one of a reference value and the standard deviation of flowrate values measured by the flowrate sensor during the reference time period or any one of the reference value and the standard deviation when the reference value and the standard deviation are equal to each other. After the applying of the zero point calibration value, the actions of determining that the fluid is stable, determining that the reference time period for measurement by the pressure meter, the flowrate sensor, and a thermometer provided in the main flow path has elapsed, calculating a zero point calibration value, and applying the zero point calibration value are repeated until the applying of the zero point calibration value is performed N or more times where N is a preselected natural number greater than or equal to 1.

### BRIEF DESCRIPTION OF THE DRAWINGS

Embodiments will be more clearly understood from the following detailed description taken in conjunction with the accompanying drawings in which:

FIG. 1 is a schematic diagram illustrating a mass flow control device according to an embodiment;

FIG. 2 is a flowchart illustrating a method of calibrating the zero point of a mass flow control device according to an embodiment;

FIG. 3 is a flowchart illustrating a method of calibrating the zero point of a flowrate sensor of a mass flow control device according to an embodiment;

FIG. 4 is a flowchart illustrating a method of calibrating the zero point of a flowrate sensor of a mass flow control device according to an embodiment;

FIG. 5 is a flowchart illustrating a method of calibrating the zero point of a flowrate sensor of a mass flow control device according to an embodiment;

FIG. 6 is a flowchart illustrating how to calibrate the zero point of a flowrate sensor of a mass flow control device according to an embodiment;

FIG. 7 is a flowchart illustrating how to calibrate the zero point of a flowrate sensor of a mass flow control device according to an embodiment;

FIG. 8 is a graph illustrating experimental results of calibrating the zero point of a mass flow control device according to an embodiment; and

FIG. 9 is a graph illustrating results of an application of a method of calibrating the zero point of a mass flow control device to a facility according to an embodiment.

### DETAILED DESCRIPTION OF THE EMBODIMENTS

Hereinafter, embodiments will be described with reference to the accompanying drawings. In the drawings, like reference numerals denote like elements, and redundant descriptions thereof may be omitted.

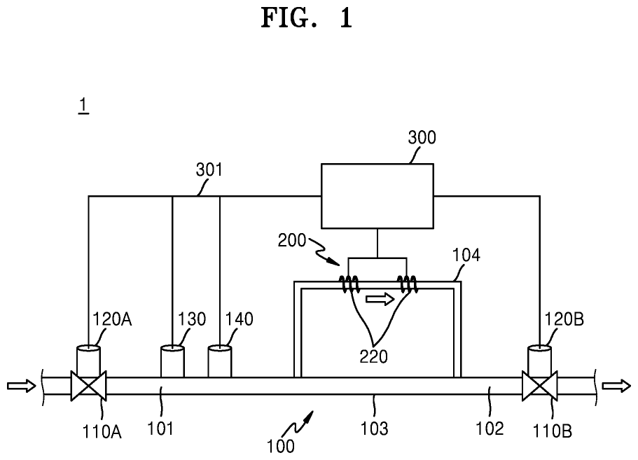

FIG. 1 is a diagram schematically illustrating a mass flow control device 1 according to an embodiment.

Referring to FIG. 1, the mass flow control device 1 (or mass flow controller: MFC) may include: a main flow path 100 including an inflow path 101, an outflow path 102, and a bypass flow path 103 extending between the inflow path 101 and the outflow path 102; a sensor flow path 104 extending between the inflow path 101 and the outflow path 102; a first valve 110A provided in the inflow path 101 and a second valve 110B provided in the outflow path 102; a pressure meter 130 and a thermometer 140 that are provided in the main flow path 100 between the first valve 110A and the second valve 110B; a flowrate sensor 200 provided in the sensor flow path 104; and a controller 300. The term “flow path,” or “path” as used herein refers to an enclosed channel (e.g., tube, pipe, etc.) through which a fluid may flow, unless the context indicates otherwise.

Mass flow control devices may be largely classified into thermal types and differential pressure types. The mass flow control device 1 of FIG. 1 is depicted as a thermal mass flow control device corresponding to some embodiments. Also, the flowrate sensor 200 may be a capillary flowrate sensor.

In an embodiment, the mass flow control device 1 may be configured to control the flow of a fluid such as a gas through the mass flow control device 1. The mass flow control device 1 may be configured to measure and control the flowrate of the fluid to be supplied to a processing device. Examples of the processing device include various processing devices such as an exposure device, a development device, and a cleaning device. Embodiments of the present disclosure are not limited to a particular type of processing device such as the preceding examples.

As shown in FIG. 1, the fluid may be introduced into the mass flow control device 1 through the inflow path 101. The fluid may pass through the mass flow control device via the main flow path 100. The fluid may flow through the inflow path 101, the bypass flow path 103 (bypassing the sensor flow path 104), and the outflow path 102 of the main flow path 100 and then exit the mass flow control device 1 to be used in manufacturing of a semiconductor device, such as for an exposure process, a development or etching process (e.g., the fluid is an etchant to etch a wafer from which the semiconductor device is being formed) or a cleaning process (e.g., the fluid is a cleaning fluid to clean the wafer).

The bypass flow path 103 may have resistance against the flow of the fluid. Because of fluid resistance applied by the bypass flow path 103, a certain percentage of the fluid flowing through the main flow path 100 may flow into the sensor flow path 104.

The first valve 110A may be provided in the inflow path 101, and the second valve 110B may be provided in the outflow path 102. The first valve 110A and/or the second valve 110B may be provided inside the mass flow control device 1. The first valve 110A and the second valve 110B may be configured to be manually or automatically opened and closed to regulate the flow of the fluid through the mass flow control device. In an embodiment, the first valve 110A and the second valve 110B may be automatically opened and closed. The first valve 110A may be provided with a first actuator 120A for opening and closing the first valve 110A. The second valve 110B may be provided with a second actuator 120B for opening and closing the second valve 110B. The first actuator 120A and the second actuator 120B may provide rotation power to the first valve 110A and the second valve 110B for opening and closing the first valve 110A and the second valve 110B. However, the configuration of the first actuator 120A, the second actuator 120B, the first valve 110A, and the second valve 110B is not limited thereto.

The first actuator 120A and the second actuator 120B may be operated by the controller 300. The controller 300 may exchange electrical signals with the first actuator 120A and the second actuator 120B in a wireless manner and/or a wired manner. The controller 300 may be a microcontroller, a CPU, a computer, etc. In an embodiment, the first actuator 120A and the second actuator 120B may be electrically connected to the controller 300 through signal wires 301. In some embodiments, the controller 300 may operate the first actuator 120A and the second actuator 120B to regulate a flow rate in the mass flow control device based on measured flow rate in the sensor flow path 104. The first and second actuators 120A and 120B may be motors (e.g., servomotors). The pressure meter 130 and the thermometer 140 may be provided in the main flow path 100 between the first valve 110A and the second valve 110B. The pressure meter 130 may measure the pressure of the fluid flowing in the main flow path 100 between the first valve 110A and the second valve 110B. The thermometer 140 may measure the temperature of the fluid flowing in the main flow path 100 between the first valve 110A and the second valve 110B.

The pressure meter 130 and the thermometer 140 may be configured to measure the pressure and the temperature of the fluid in the main flow path 100 at predetermined time intervals as described later. The pressure meter 130 and the thermometer 140 may be connected to the controller 300 in a wired manner and/or a wireless manner for transmission of electrical signals therebetween. In an embodiment, the pressure meter 130 and the thermometer 140 may be electrically connected to the controller 300 through signal wires 301 to transmit measured values to the controller 300.

The flowrate sensor 200 may be provided on the sensor flow path 104. The flowrate sensor 200 may include a sensor wire 220 provided around the sensor flow path 104. In some embodiments, the flowrate sensor 200 may include multiple sensor wires that may be positioned in different locations along the sensor flow path 104.

In an embodiment, the sensor wire 220 may generate heat such as by passing a current through the sensor wire 220, and then the heat generated by the sensor wire 220 may be transferred to the fluid flowing in the sensor flow path 104. Thus, the temperature of the fluid flowing in the sensor flow path 104 may rise as it travels downstream in the sensor flow path 104. A portion of the sensor wire 220 located relatively upstream of the sensor flow path 104 may transfer heat to the fluid at its provided temperature (before the fluid is heated), thereby cooling the portion of the sensor wire 220 located relatively upstream and heating the fluid passing that location. A portion of the sensor wire 220 located relatively downstream of the sensor flow path 104 may transfer heat to the fluid after the fluid is heated to some degree by the portion of the sensor wire 220 located relatively upstream thereby cooling the portion of the sensor wire 220 located relatively downstream. Because the fluid may be at an elevated temperature proximate to the portion of the sensor wire 220 located relatively downstream due to the heat transferred from the portion of the sensor wire 220 located relatively upstream, the portion of the sensor wire 220 located relatively downstream may be cooled a lower amount (to a lesser degree) than the portion of the sensor wire 220 located relatively upstream was cooled.

Therefore, the temperature of the upstream portion of the sensor wire 220 may be lower than the temperature of the downstream portion of the sensor wire 220. Due to this temperature difference along the sensor wire 220, the electrical resistance of the sensor wire 220 may vary for different portions of the sensor wire 220. The difference in electrical resistance can be used to measure the flowrate of the fluid flowing in the sensor flow path 104. In some embodiments, the difference in temperature may be measured as a ratio between the resistance of the different portions of the sensor wire 220. However, since the different portions of the sensor wire 220 and the heat applied to the sensor wire 220 may vary, a difference in electrical resistance may exist even when the flow rate is zero. Thus, when measuring the flowrate, the difference in resistance of the portions of the sensor wire 220 when the flowrate is zero should be accounted for by a zero point calibration value. In some embodiments, the zero point calibration value may be subtracted from the difference in the measured resistance of the portions of the sensor wire 220 to find the flowrate.

As the flowrate of the fluid flowing in the sensor flow path 104 increases, the temperature difference between the upstream portion of the sensor wire 220 and the downstream portion of the sensor wire 220 may increase. Thus, the electrical resistance difference between the upstream portion of the sensor wire 220 and the downstream portion of the sensor wire 220 may increase with increases in the flowrate. Variations in the flowrate of the fluid may be detected through detecting the variations in the electrical resistance difference by using, for example, a bridge circuit. Therefore, the flowrate of the fluid flowing in the sensor flow path 104 may be detected through detecting variations in the electrical resistance difference between the upstream portion of the sensor wire 220 and the downstream portion of the sensor wire 220. The flowrate of the fluid flowing in the main flow path 100 may be measured based on the flowrate measurement of the fluid flowing in the sensor flow path 104.

In the present disclosure, a configuration including elements, such as a bridge circuit and the sensor wire 220 provided around the sensor flow path 104 for measuring the flowrate of a fluid may be referred to as a flowrate sensor 200.

The flowrate of the fluid measured using the flowrate sensor 200 may be transmitted to the controller 300. The flowrate sensor 200 may be configured to measure the flowrate of the fluid at predetermined intervals as described later. The flowrate sensor 200 may be connected to the controller 300 in a wired manner and/or a wireless manner, and thus electrical signals relating to the flowrate of the flow may be transmitted between the flowrate sensor 200 and the controller 300. In an embodiment, the flowrate sensor 200 may be electrically connected to the controller 300 through a signal wire 301 to transmit measured flowrate values to the controller 300.

In an embodiment, the controller 300 may implement a method for a zero point calibration (described later) such that the controller 300 may calibrate the zero point of the mass flow control device 1. In an embodiment, the controller 300 may receive measured values respectively from the pressure meter 130, the thermometer 140, and the flowrate sensor 200 to perform a zero point calibration method for the mass flow control device 1.

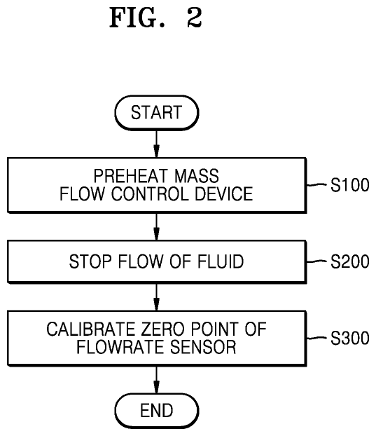

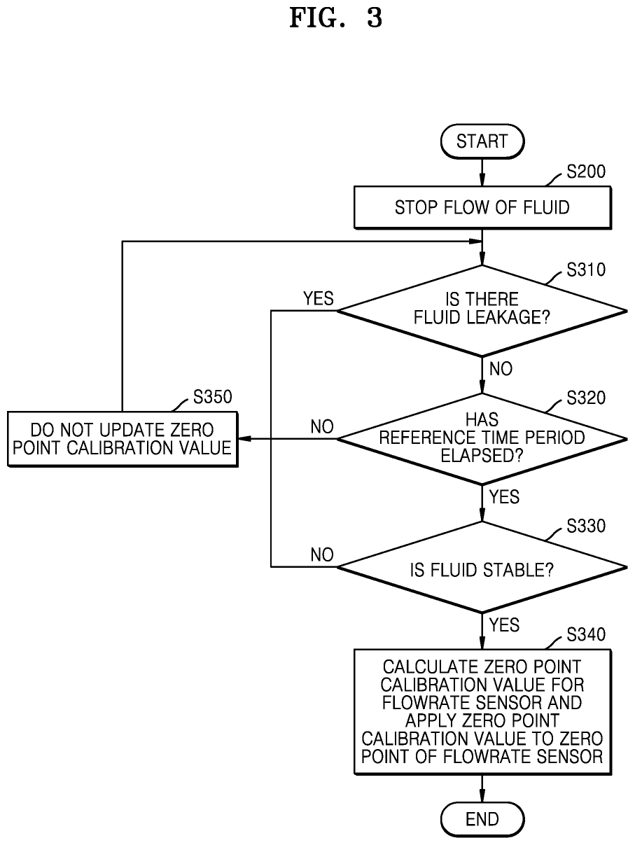

FIG. 2 is a flowchart illustrating a zero point calibration method for the mass flow control device 1, according to an embodiment. FIG. 3 is a flowchart illustrating how to calibrate the zero point of the flowrate sensor 200 of the mass flow control device 1, according to an embodiment.

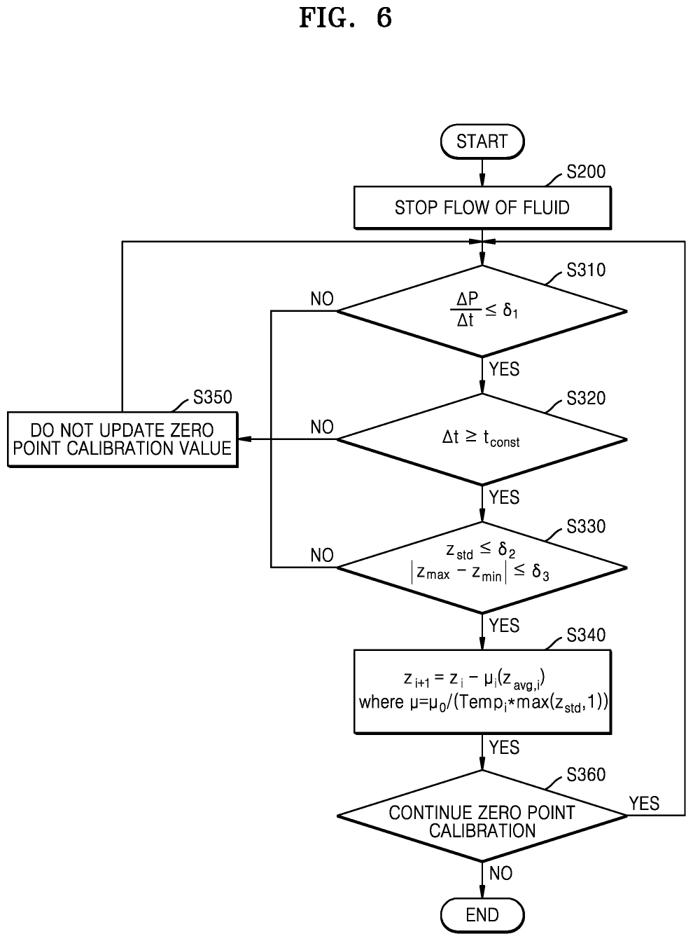

Referring to FIGS. 2 and 3, according to an embodiment, the zero point calibration method for the mass flow control device 1 may include: preheating the mass flow control device 1 including the flowrate sensor 200 (operation S100); stopping the flow of a fluid through the mass flow control device 1 for calibrating the zero point of the flowrate sensor 200 (operation S200); and calibrating the zero point of the flowrate sensor 200 based on pressure, temperature, and flowrate values measured by the mass flow control device 1 (operation S300) while the flow is stopped. FIG. 6 provides exemplary details of operations S310, S320, S330 and S340 that may be implemented with the corresponding operations of the embodiments described elsewhere herein. For ease of illustration, the following description will be given with reference to FIG. 6 as well as FIGS. 2 and 3.

As described above, operation S100 of preheating the mass flow control device 1 may include preheating the sensor wire 220 of the flowrate sensor 200. The sensor wire 220 may be preheated externally by a heating element or may be preheated internally, such as by passing a current through the sensor wire 220.

In operation S200 of stopping the flow of the fluid, the flow of the fluid in the main flow path 100 may be stopped by closing at least one valve. According to an embodiment, the flow of the fluid in the main flow path 100 may be stopped between the first valve 110A and the second valve 110B by closing the first valve 110A and the second valve 110B.

In operation S300 of calibrating the zero point of the flowrate sensor 200, the zero point of the flowrate sensor 200 may be calibrated using values measured by the pressure meter 130, the thermometer 140, and the flowrate sensor 200 while the flow is stopped. Operation S300 of calibrating the zero point of the flowrate sensor 200 will be further described.

Operation S300 of calibrating the zero point of the flowrate sensor 200 may be performed as shown in FIG. 3. Referring to FIG. 3, in operation S200, the flow of the fluid through the mass flow control device 1 may be stopped for calibrating the zero point of the flowrate sensor 200. Operation S200 shown in FIG. 3 may be the same as operation S200 shown in FIG. 2.

Operation S300 of calibrating the zero point of the flowrate sensor 200 may include: determining, based on a pressure value measured by the pressure meter 130 installed in the main flow path 100, whether there is a fluid leakage (operation S310); determining, based on a flowrate value measured by the flowrate sensor 200 provided on the sensor flow path 104 connected to the main flow path 100, whether the fluid is stable (operation S330); and calculating a zero point calibration value based on a temperature value measured by the thermometer 140 installed in the main flow path 100 and the flowrate value measured by the flowrate sensor 200 and applying the zero point calibration value to the zero point of the flowrate sensor 200 (operation S340). Applying the zero point calibration value to the zero point of the flowrate sensor 200 may update the zero point of the flowrate sensor based upon the calculated zero point calibration value.

After the zero point calibration value is applied to the zero point of the flowrate sensor 200 the flow of the fluid can be unblocked by opening a valve such as the first valve 110A and/or the second valve 110B. The fluid is then able to flow through the mass flow control device and the flowrate sensor is operable to measure the flowrate of the fluid flowing along the main flow path 100 using the updated zero point of the flowrate sensor. The valves may be adjusted based on the measured flowrate of the fluid to regulate the flowrate of the fluid passing through the mass flow control device to a controlled amount as measured by the flowrate sensor 200. The controller 300 may automatically adjust the valves to regulate the controlled amount flowing through the mass flow control device in view of fluctuations in the upstream delivery of the gas.

The zero point of the flowrate sensor 200 may be stored by the controller 300 and used by the controller 300 to determine the flowrate based on a signal from the flowrate sensor 200. Alternatively, the flowrate sensor 200 may store the zero point and output a flowrate signal to the controller 300 that accounts for the zero point. In some embodiments, the controller 300 may be a part of the flowrate sensor 200 such that updating a zero point of the flowrate sensor 200 includes updating the zero point of the controller 300.

As shown in FIG. 6, operation S310 of determining whether there is a fluid leakage may be performed by monitoring the rate (ΔP/Δt) of change of pressure with respect to time using pressure values measured by the pressure meter 130 and time intervals between the pressure measurements. Here, Δt refers to time intervals at which pressure values are measured, and ΔP refers to the change of pressure measured at the time intervals. Thus, ΔP/Δt refers to the rate of change of pressure with respect to time. δ₁ is a reference value, and when the rate of change of pressure with respect to time is less than or equal to the reference value, it is considered that the change of fluid pressure in the main flow path 100 is relatively small. Therefore, when the rate of change of pressure with respect time is small (e.g., less than or equal to the reference value), it may be determined that the fluid has stopped flowing and is stationary.

However, when the rate of change of pressure with respect to time is greater than the reference value, it may be determined that the fluid may still be flowing such as if the flow of the fluid is not securely stopped by a valve. In this case, an operator may check, for example, whether the valve is securely closed, and may make another attempt to securely stop the flow of the fluid using the valve.

That is, through operation S310 of determining whether there is a fluid leakage, it may be determined whether the flow of the fluid is stopped by a valve. By verifying that the flow of the fluid is stopped, it is possible to calibrate the zero point of the mass flow control device 1 according to an embodiment.

In operation S310 of determining whether there is a fluid leakage, when it is determined that the amount of leakage of the fluid is greater than the reference value indicating that the fluid is still flowing, the following operations, that is, operation S330 of determining whether the fluid is stable, and operation S340 of calculating a zero point calibration value and applying the zero point calibration value to the zero point of the flowrate sensor 200, may not be performed. That is, a zero point calibration value may not be applied to an existing zero point value. In other words, a zero point calibration value may not be updated (operation S350). Thereafter, operation S310 of determining whether there is a fluid leakage may be performed again. For example, the valve may be initially closed and operation S310 performed to determine if the flow is stopped. If the operation S310 determines that the flow is not stopped, then the valves may be opened and the method may begin again, starting with closing the valve installed in the main flow path 100 of the mass flow control device.

Thus, owing to operation S310 of determining whether there is a fluid leakage indicating that the fluid is still flowing, it is possible to determine whether the mass flow control device 1 is in a state suitable for zero point calibration according to an embodiment. Owing to operation S310 of determining whether there is a fluid leakage, it is possible to stably and accurately calibrate the zero point of the mass flow control device 1.

Operation S330, in which whether the fluid is stable is determined based on a flowrate value measured by the flowrate sensor 200 provided on the sensor flow path 104 connected to the main flow path 100, may be performed using flowrate values measured by the flowrate sensor 200 within a reference time period and a standard deviation of the flowrate values measured within the reference time period.

As shown in FIG. 6, when the standard deviation z_{std} of flowrate values is less than or equal to a reference value δ₂, it may be considered that the flowrate values measured by the flowrate sensor 200 do not largely vary but are relatively stable within a predetermined range.

The difference between the maximum flowrate value Zₘₐₓ and the minimum flowrate value Zₘᵢₙ among the flowrate values measured within the reference time period may be calculated as |Zₘₐₓ−Zₘᵢₙ|.

When the absolute value of the difference |Zₘₐₓ−Zₘᵢₙ| between the maximum flowrate value Zₘₐₓ and the minimum flowrate value Zₘᵢₙ is less than or equal to a reference value δ₃, it may be considered that the flowrate values measured by the flowrate sensor 200 do not largely vary but are relatively stable compared with the case in which the absolute value of the difference |Zₘₐₓ−Zₘᵢₙ| between the maximum flowrate value Zₘₐₓ and the minimum flowrate value Zₘᵢₙ is greater than the reference value δ₃.

That is, when the flowrate standard deviation z_{std} is less than or equal to the reference value δ₂, and the absolute value of the difference |Zₘₐₓ−Zₘᵢₙ| between the maximum flowrate value Zₘₐₓ and the minimum flowrate value Zₘᵢₙ is less than or equal to the reference value δ₃, it may be considered that the flowrate values measured by the flowrate sensor 200 are stable.

Therefore, owing to operation S330 of determining whether the fluid is stable, it is possible to determine whether the mass flow control device 1 is in a state suitable for zero point calibration according to an embodiment. Owing to operation S330 of determining whether the fluid is stable, it is possible to stably and accurately calibrate the zero point of the mass flow control device 1.

In operation S330 of determining whether the fluid is stable, when the given conditions are not satisfied, the next operation S340 of calculating a zero point calibration value and applying the zero point calibration value to the zero point of the flowrate sensor 200 may not be performed. That is, the zero point calibration value is not updated (operation S350). Thereafter, operation S310 may be performed again to determine whether there is a fluid leakage.

According to an embodiment, the zero point calibration method for the mass flow control device 1 may further include operation S320 of determining whether the reference time period during which the pressure meter 130, the thermometer 140, and the flowrate sensor 200 perform measurements has elapsed.

In an embodiment, operation S320 of determining whether the reference time period has elapsed may be performed after operation S310 of determining whether there is a fluid leakage and before operation S330 of determining whether the fluid is stable.

Operation S320 of determining whether the reference time period has elapsed may be for determining whether the reference time period during which the pressure meter 130, the thermometer 140, and the flowrate sensor 200 perform measurements has elapsed.

As described above, operation S310 of determining whether there is a fluid leakage may be performed based on the rate (ΔP/Δt) of change of pressure with respect time using pressure values measured by the pressure meter 130 and the time interval between the pressure measurements. Here, the time interval (Δt) may be used as the reference time period in operation S320 of determining whether the reference time period has elapsed.

Similarly, as described above, operation S330 of determining whether the fluid is stable may be performed using flowrate values measured by the flowrate sensor 200 within the reference time period and the standard deviation of the flowrate values measured within the reference time period. The reference time period in operation S330 of determining whether the fluid is stable may be the same as the reference time period in operation S320 of determining whether the reference time period has elapsed.

As shown in FIG. 6, when an elapsed time period (Δt) is greater than or equal to the reference time period (t_{const}) in operation S320 of determining whether the reference time period has elapsed, the pressure meter 130, the thermometer 140, and the flowrate sensor 200 may have a sufficient time period for measurement.

Owing to operation S320 of determining whether the reference time period has elapsed, a time period during which the mass flow control device 1 performs measurement for zero point calibration may be secured according to an embodiment. Therefore, owing to operation S320 of determining whether the reference time period has elapsed, it is possible to stably and accurately calibrate the zero point of the mass flow control device 1.

When the given condition is not satisfied in operation S320 of determining whether the reference time period has elapsed, operation S330 of determining whether the fluid is stable and operation S340 of calculating a zero point calibration value and applying the zero point calibration value to the zero point of the flowrate sensor 200 are not performed after operation S320. That is, the zero point calibration value is not updated (operation S350). Thereafter, operation S310 of determining whether there is a fluid leakage may be performed again.

After operation S330 of determining whether the fluid is stable, operation S340 may be performed to calculate a zero point calibration value based on a temperature value measured by the thermometer 140 installed in the main flow path 100 and a flowrate value measured by the flowrate sensor 200, and to apply the zero point calibration value to the zero point of the flowrate sensor 200.

Alternatively, the calculating of the zero point calibration value based on a temperature value measured by the thermometer 140 installed in the main flow path 100 and a flowrate value measured by the flowrate sensor 200 may be performed separately from the applying of the zero point calibration value to the zero point of the flowrate sensor 200.

The zero point calibration value may be proportional to an average flowrate calculated from flowrate values measured by the flowrate sensor 200 over time while the fluid is stopped. The zero point calibration value may be proportional to a calibration weight value. The calibration weight value may be inversely proportional to a temperature value measured by the thermometer 140. The calibration weight value may be inversely proportional to the greater one of a flowrate standard deviation, calculated from flowrate values measured during the reference time period by the flowrate sensor 200, and a reference value (any one of the flowrate standard deviation and the reference value when the flowrate standard deviation and the reference value are equal to each other). The zero point calibration value may be applied to the existing zero point of the flowrate sensor 200 by subtracting the zero point calibration value from the existing zero point.

Referring to FIG. 6, subscript ‘i’ is used to indicate a value in an i-th time period, and an (i+1)th time period is a time period subsequent to the i-th time period.

A zero point calibration value may be represented as μᵢ·(z_{avg,i}), where a calibration weight value μᵢ is a calibration weight value μ corresponding to the i-th time period and z_{avg,i} is an average flowrate value calculated during the i-th time period. The zero point calibration value μᵢ·(z_{avg,i}) may be proportional to an average flowrate value z_{avg,i} calculated based on flowrate values measured by the flowrate sensor 200 over time during the i-th time period. In a state in which the fluid is stationary, calculating a large average flowrate value z_{avg,i} may indicate that the zero point of the flowrate sensor 200 is not correct as the calculated average flowrate value z_{avg,i}. should be small (zero or close to zero).

The zero point calibration value μᵢ·(z_{avg,i}) also may be proportional to the calibration weight value μ. The calibration weight value μ may be inversely proportional to a temperature value Tempᵢ measured by the thermometer 140. The greater the temperature value Tempᵢ measured by the thermometer 140, the greater the gas (fluid) may flow. As the temperature value Tempᵢ measured by the thermometer 140 increases, the calibration weight value μ may be decreased such that the flow of the gas varying according to temperature may have a lesser effect on the zero point calibration value μᵢ·(z_{avg,i}).

The calibration weight value μ may be inversely proportional to a value max(z_{std}, δ₂) that is the greater one of the reference value δ₂ and the flowrate standard deviation z_{std} calculated from flowrate values measured by the flowrate sensor 200 during the reference time period (any one of the reference value δ₂ and the flowrate standard deviation when the reference value δ₂ and the flowrate standard deviation are equal to each other). For example, the reference value may be 1 and the calibration weight value μ may be inversely proportional to max(z_{std}, 1). When the flowrate standard deviation z_{std} is the greater one, the flow of the fluid may be relatively less stable. Therefore, the calibration weight value μ may be set to be inversely proportional to the value max(z_{std}, 1), which is the greater one of the flowrate standard deviation z_{std} and the reference value or any one of the two when the two are equal to each other, and thus the calibration weight value μ may be reduced when the flowrate of the fluid is relatively less stable.

The zero point calibration value μᵢ·(z_{avg,i}) may be applied to an existing zero point zᵢ by subtracting the zero point calibration value μᵢ·(z_{avg,i}) from the existing zero point zᵢ. An updated zero point zᵢ₊₁ may be obtained by subtracting the zero point calibration value μᵢ·(z_{avg,i}) from the existing zero point zᵢ.

The zero point calibration value μᵢ·(z_{avg,i}) may be proportional to a zero point calibration constant μ₀. The zero point calibration constant μ₀ may be an appropriately selected, predetermined constant. In an embodiment, the zero point calibration constant μ₀ may be selected from a range from about 0.5 to about 1.

After operation S340 of calculating a zero point calibration value and applying the zero point calibration value to the zero point of the flowrate sensor 200, the zero point calibration method for the mass flow control device 1 may be completed according to an embodiment.

According to embodiments, the zero point calibration method may be performed to calibrate the zero point of the mass flow control device 1 by considering the surrounding environment, the fluid state, and the fluid flow state of the mass flow control device 1. Because the calibration of the zero point of the mass flow control device 1 is improved as described above, the amounts of fluids to be supplied to processing devices may be precisely controlled using the mass flow control device 1, and thus the quality of results of processing may be improved. In addition, zero point calibration may be automated to reduce manpower and process time.

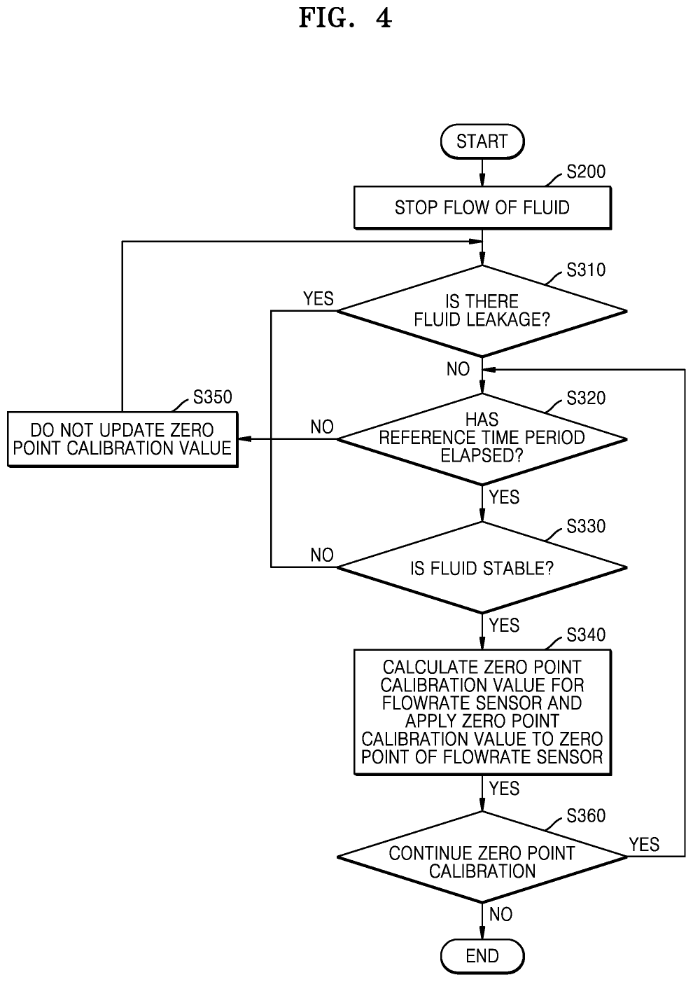

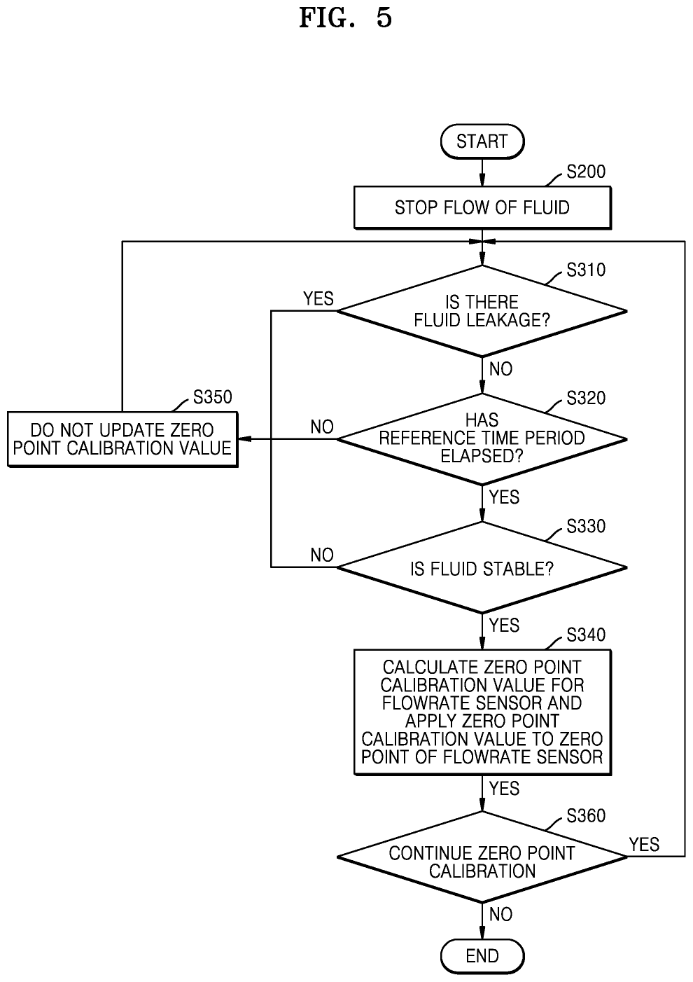

FIG. 4 is a flowchart illustrating the zero point calibration method for the flowrate sensor 200 of the mass flow control device 1 according to an embodiment. FIG. 5 is a flowchart illustrating the zero point calibration method for the flowrate sensor 200 of the mass flow control device 1 according to an embodiment. In the following description, those elements described previously may not be described again.

Referring to FIGS. 4 and 5, after operation S340 of calculating a zero point calibration value and applying the zero point calibration value to the zero point of the flowrate sensor 200, the zero point calibration method may further include operation S360 of determining whether to continue the zero point calibration.

In an embodiment, the zero point of the flowrate sensor 200 of the mass flow control device 1 may be repeatedly calibrated to accurately calibrate the zero point of the flowrate sensor 200 of the mass flow control device 1. According to an embodiment, an operator and/or the controller 300 may repeat the zero point calibration of the mass flow control device 1.

As shown in FIG. 4, in operation S360 of determining whether to continue the zero point calibration, when it is determined to continue zero point calibration, zero point calibration may be performed again from operation S320 of determining whether the reference time period has elapsed, which is the next operation after operation S310 of determining whether there is a fluid leakage.

Alternatively, as shown in FIG. 5, in operation S360 of determining whether to continue zero point calibration, when it is determined to continue zero point calibration, zero point calibration may be performed again from operation S310 of determining whether there is a fluid leakage.

FIG. 6 is a flowchart illustrating how to calibrate the zero point of the flowrate sensor 200 of the mass flow control device 1 according to an embodiment. Because FIG. 6 has been described together with FIGS. 3 to 5, FIG. 6 will not be described here.

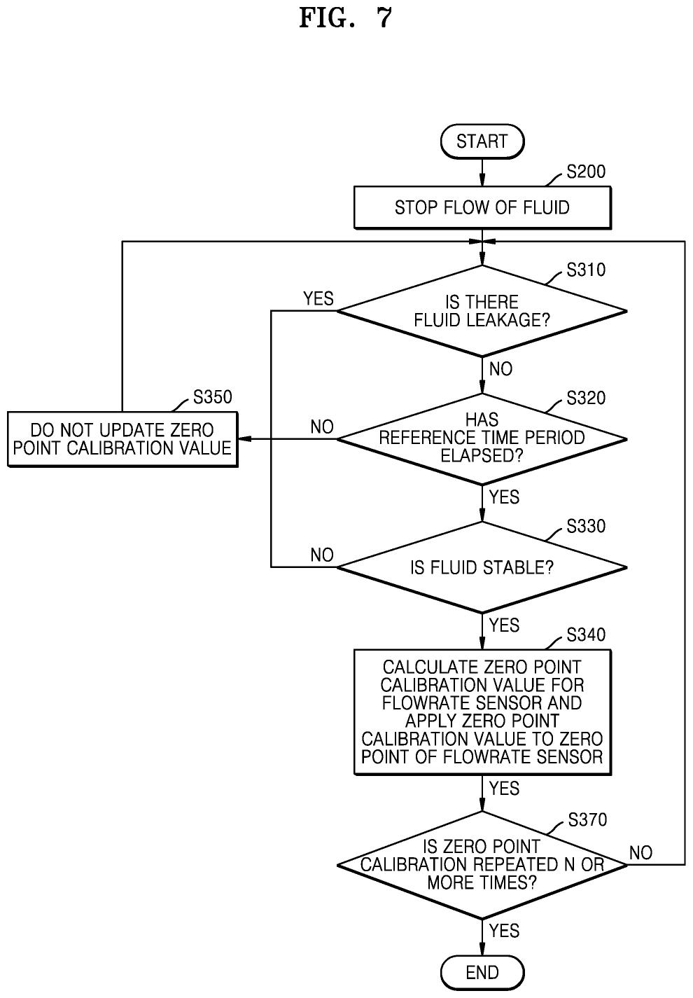

FIG. 7 is a flowchart illustrating the zero point calibration method for the flowrate sensor 200 of the mass flow control device 1 according to an embodiment. Those elements described previously may not be described again.

Referring to FIG. 7, S360 of determining whether to continue zero point calibration may be replaced with operation S370 of determining whether the zero point calibration has been repeated N times (where N is a natural number greater than or equal to 1). For example, after applying a first calculated zero point calibration value to the zero point of the flowrate sensor 200, a second zero point calibration value can be calculated based on a second temperature value of the fluid measured by the thermometer 140 and a second flowrate value measured by the flowrate sensor 200 using the calculated zero point calibration value. The second calculated zero point calibration value can then be applied to the zero point of the flowrate sensor 200 and the process can be repeated a number of times.

After the zero point of the flowrate sensor 200 is calibrated a sufficient number of times, the zero point calibration method may be automatically terminated. In this manner, the start, the zero point calibration, and the termination of the zero point calibration method may all be automated for the flowrate sensor 200 of the mass flow control device 1 according to an embodiment.

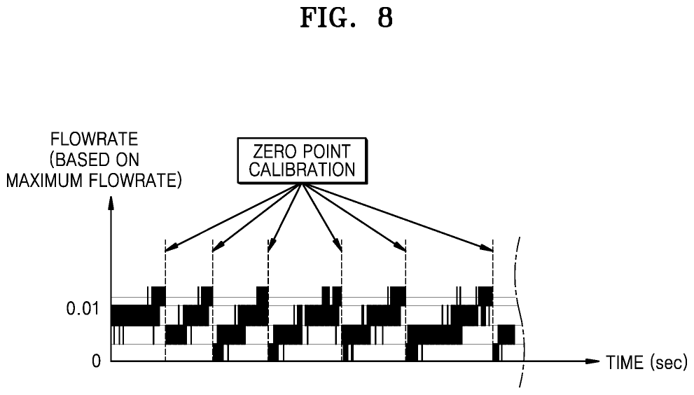

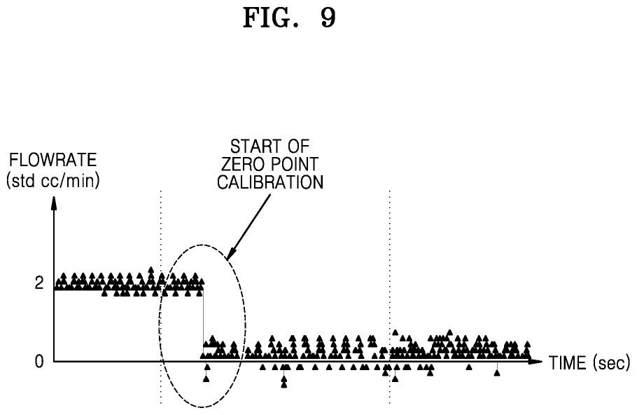

FIG. 8 is a graph illustrating experimental results of the zero point calibration method for the mass flow control device 1 according to an embodiment. FIG. 9 is a graph illustrating results of an application of the zero point calibration method for the mass flow control device 1 to a facility according to an embodiment.

Referring to FIG. 8, the vertical axis refers to the ratio of a flowrate measured by the flowrate sensor 200 to a maximum flowrate, and the horizontal axis refers to time in seconds.

When the zero point calibration of the flowrate sensor 200 of the mass flow control device 1 was periodically performed by the zero point calibration method according to an embodiment, the zero point of the flowrate sensor 200 of the mass flow control device 1 was properly set as shown in FIG. 8. Each time the zero point of the mass flow control device 1 was calibrated using values measured by the pressure meter 130, the thermometer 140, and the flowrate sensor 200, a measured flowrate moved toward the zero point of the mass flow control device 1.

Referring to FIG. 9, the vertical axis refers to the flowrate of gas per minute (cc/min) under a specific standard condition. The horizontal axis refers to time in seconds.

Before zero point calibration was performed, a flowrate of 2 cc/min was measured even though the gas (fluid) was stationary and there was no flow in the main flow path 100. That is, the flowrate sensor 200 detected a supply of the fluid even though the fluid was actually stationary and was not supplied.

After the zero point of the mass flow control device 1 was constantly calibrated by the zero point calibration method according to an embodiment, flowrates close to 0 cc/min were measured as shown in FIG. 9.

According to embodiments, the zero point calibration method for the mass flow control device 1 may reduce zero point errors caused by aging of the flowrate sensor 200 or ambient temperature variations. That is, the fluid is stabilized prior to the calculation of a zero point calibration value, and then a zero point calibration value is calculated based on the average flowrate of the fluid and the standard deviation of flowrate values. Therefore, zero point calibration may be performed by considering fluid states.

Because the inventive concept improves zero point calibration, the amounts of fluids to be supplied to processing devices may be precisely controlled using the mass flow control device 1, and thus may result in higher quality processing. In addition, zero point calibration may be automated to reduce manpower and process time compared to the case of manual zero point calibration.

While the inventive concept has been particularly shown and described with reference to embodiments thereof, it will be understood that various changes in form and details may be made therein without departing from the spirit and scope of the following claims.

What is claimed is:

1. A method of manufacturing using a mass flow control device, the method comprising:
closing a valve installed in a main flow path of the mass flow control device to block the main flow path to prevent a fluid from flowing along the main flow path;
determining, based on a pressure value measured using a pressure meter installed in the main flow path, that the fluid has stopped flowing;
determining, based on a flowrate value measured by a flowrate sensor provided on a sensor flow path connected to the main flow path, that the fluid is stable in the main flow path;
in response to determining that the fluid has stopped flowing and that the fluid is stable in the main flow path, calculating a zero point calibration value based on a temperature value of the fluid measured by a thermometer installed in the main flow path and the flowrate value measured by the flowrate sensor;
updating a zero point of the flowrate sensor based upon the calculated zero point calibration value; and
opening the valve installed in a main flow path of the mass flow control device to unblock the main flow path and measuring the flowrate of the fluid flowing along the main flow path with the flowrate sensor using the updated zero point of the flowrate sensor.

2. The method of claim 1, wherein the determining that the fluid does not leak comprises determining that a rate of change of the pressure value with respect to time is less than or equal to a reference value.

3. The method of claim 1, wherein, between the determining the fluid has stopped flowing and determining the fluid is stable, the method further comprises determining that a reference time period for measurement by the pressure meter, the flowrate sensor, and the thermometer has elapsed.

4. The method of claim 3, wherein the determining the fluid is stable comprises determining that the fluid is stable when a standard deviation of flowrate values measured by the flowrate sensor during the reference time period is less than or equal to a reference value.

5. The method of claim 3, wherein the determining the fluid is stable comprises determining that the fluid is stable when a difference between a maximum value and a minimum value of the flowrate measured by the flowrate sensor during the reference time period is less than or equal to a reference value.

6. The method of claim 3, wherein the reference time period ranges from about 5 seconds to about 30 seconds.

7. The method of claim 1, wherein the calculating of the zero point calibration value comprises:
calculating the zero point calibration value in proportion to an average flowrate of flowrate values measured by the flowrate sensor over time; and
updating an existing zero point value by subtracting the zero point calibration value from the existing zero point value.

8. The method of claim 7, wherein
the zero point calibration value is proportional to a calibration weight value,
the calibration weight value is inversely proportional to the temperature value measured by the thermometer, and
the calibration weight value is inversely proportional to a greater one of a reference value and a flowrate standard deviation calculated from flowrate values measured by the flowrate sensor during a reference time period, or is inversely proportional to any one of the reference value and the flowrate standard deviation when the reference value and the flowrate standard deviation are equal to each other.

9. The method of claim 3, wherein the method further comprises:
initially closing the valve to block the main flow path and prevent the fluid from flowing along the main flow path;
determining at least one of that the fluid is still flowing, that the fluid is not stable in the main flow path, or that the reference time period has not elapsed after the initial closing the valve; and
opening the valve responsive to determining at least one of that the fluid is still flowing, that the fluid is not stable in the main flow path, or that the reference time period has not elapsed after the initial closing the valve.

10. The method of claim 9, wherein after updating a zero point of the flowrate sensor based upon the calculated zero point calibration value, the method further comprises:
determining, based on a second flowrate value measured by the flowrate sensor, that the fluid is stable in the main flow path;
in response to determining that the fluid is stable in the main flow path, calculating a second zero point calibration value based on a second temperature value of the fluid measured by the thermometer and a second flowrate value measured by the flowrate sensor using the calculated zero point calibration value; and
applying the second calculated zero point calibration value to the zero point of the flowrate sensor.

11. The method of claim 10, wherein after the applying of the second calculated zero point calibration value to the zero point of the flowrate sensor, when it is determined that the applying of the second calculated zero point calibration value to the zero point of the flowrate sensor is performed N or more times, where N is a preselected natural number greater than or equal to 1, the method is terminated.

12. A mass flow control device comprising:
a main flow path comprising an inflow path through which a fluid is introduced, an outflow path through which the fluid is discharged, and a bypass flow path extending between the inflow path and the outflow path;
a sensor flow path extending between the inflow path and the outflow path;
a first valve provided in the inflow path and a second valve provided in the outflow path;
a pressure meter and a thermometer that are provided in the main flow path between the first valve and the second valve;
a flowrate sensor provided on the sensor flow path; and
a controller configured to receive measured values from the flowrate sensor, the pressure meter, and the thermometer and calibrate a zero point of the flowrate sensor,
wherein the controller is further configured to:
determine, based on a pressure value measured by the pressure meter, whether the fluid has stopped flowing when the main flow path is closed by the first valve and the second valve;
determine, based on a flowrate value measured by the flowrate sensor, whether the fluid is stable;
calculate a zero point calibration value based on a temperature value of the fluid measured by the thermometer provided in the main flow path and the flowrate value measured by the flowrate sensor; and
calibrate the zero point of the flowrate sensor using the zero point calibration value.

13. The mass flow control device of claim 12, further comprising actuators configured to close and open the first valve and the second valve according to a control signal from the controller.

14. The mass flow control device of claim 12, wherein after applying the zero point calibration value to the zero point of the flowrate sensor, the controller is further configured to determine again whether the fluid leaks.

15. The mass flow control device of claim 12, wherein the controller is further configured such that, during a reference time period, the controller determines whether the fluid leaks, determines whether the fluid is stable, calculates the zero point calibration value, and applies the zero point calibration value to the zero point of the flowrate sensor.

16. The mass flow control device of claim 12, wherein the controller is further configured to, in response to a determination that the fluid is still flowing, skip determining whether the fluid is stable and skip calculating the zero point calibration value, and after a reference time period elapses, attempt to calibrate the zero point of the flowrate sensor again.

17. The mass flow control device of claim 12, wherein the controller is further configured to, in response to a determination that the fluid is not stable, skip calculation of the zero point calibration value, and after a reference time period, attempt to calibrate the zero point of the flowrate sensor again.

18. The mass flow control device of claim 12, wherein
the zero point calibration value is proportional to an average flowrate calculated from flowrate values measured by the flowrate sensor over time,
the zero point calibration value is proportional to a calibration weight value,
the calibration weight value is inversely proportional to the temperature value measured by the thermometer,
the calibration weight value is inversely proportional to a greater one of a reference value and a standard deviation calculated from flowrate values measured by the flowrate sensor during a reference time period, or is inversely proportional to any one of the reference value and the standard deviation when the reference value and the standard deviation are equal to each other, and
the zero point calibration value is applied to the zero point of the flowrate sensor by subtracting the zero point calibration value from the zero point.

19. The mass flow control device of claim 12, wherein the flowrate sensor is a capillary flowrate sensor, and
the mass flow control device is a thermal mass flow control device.

20. A method of manufacturing a semiconductor device using a mass flow control device, the method comprising:
closing a valve installed in a main flow path of the mass flow control device to block the main flow path and prevent a fluid from flowing along the main flow path;
determining that the fluid has stopped flowing based on a pressure value measured by a pressure meter installed in the main flow path by determining that a rate of change of the pressure value with respect to time is less than or equal to a reference value;
determining that the fluid is stable, wherein the fluid is determined to be stable when a standard deviation of flowrate values measured during a reference time period by a flowrate sensor provided on a sensor flow path connected to the main flow path is less than or equal to a reference value, and a difference between a maximum value and a minimum value of the flowrate values measured by the flowrate sensor during the reference time period is less than or equal to than a reference value;
determining that the reference time period for measurement by the pressure meter, the flowrate sensor, and a thermometer provided in the main flow path has elapsed;
calculating a zero point calibration value based on a temperature value of the fluid measured by the thermometer and the flowrate values measured by the flowrate sensor;
updating a zero point of the flowrate sensor based upon the zero point calibration value; and
opening the valve installed in a main flow path of the mass flow control device to unblock the main flow path and measuring the flowrate of the fluid flowing along the main flow path with the flowrate sensor using the updated zero point of the flowrate sensor,
wherein the zero point calibration value is proportional to an average flowrate calculated from flowrate values measured by the flowrate sensor over time and is proportional to a calibration weight value,
the calibration weight value is inversely proportional to the temperature value measured by the thermometer, and is inversely proportional to a greater one of a reference value and the standard deviation of flowrate values measured by the flowrate sensor during the reference time period or any one of the reference value and the standard deviation when the reference value and the standard deviation are equal to each other, and
after updating a zero point of the flowrate sensor based upon the calculated zero point calibration value, the actions of determining that the fluid is stable, determining that the reference time period for measurement by the pressure meter, the flowrate sensor, and a thermometer provided in the main flow path has elapsed, calculating a zero point calibration value, and applying the zero point calibration value are repeated until the action of applying of the zero point calibration value is performed N or more times, where N is a preselected natural number greater than or equal to 1.
